(19) United States
(12) Patent Application Publication
(10) Pub. No.: US 2026/0158395 A1
(43) Pub. Date: Jun. 11, 2026

(54) COMPUTER GAME GENERATION USING LANGUAGE MODEL AND DIFFUSION MODEL

(71) Applicants: Lemon Inc., Grand Cayman (KY); Beijing Zitiao Network Technology Co., Ltd., Beijing (CN)

(72) Inventors: Jonathan Guzi, Culver City, CA (US); Felicity Wing Tin Yick, Los Angeles, CA (US); Blake Garrett Fuselier, Los Angeles, CA (US); Peilin Li, Los Angeles, CA (US); Runze Zhang, Los Angeles, CA (US); Jie Meng, Los Angeles, CA (US); Shiyuan Liu, Beijing (CN); Jagminder Singh Shergill, Los Angeles, CA (US); Lorne Zhang, Los Angeles, CA (US); Jiamin Yuan, Los Angeles, CA (US); Runjia Tian, Los Angeles, CA (US)

(21) Appl. No.: 18/977,163

(22) Filed: Dec. 11, 2024

(51) Int. Cl. A63F 13/67; A63F 13/56; A63F 13/63; G06F 40/40; G06T 3/40; G06T 11/00

(52) U.S. Cl. CPC A63F 13/67; A63F 13/56; A63F 13/63; G06F 40/40; G06T 3/40; G06T 11/00; G06T 2200/24

(57) ABSTRACT

A computerized method is provided including displaying a chat interface configured to receive natural language user input, executing a language model agent configured to interface with a generative language model to obtain game parameter values based on the natural language user input, and executing a diffusion model agent configured to interface with a diffusion model to obtain an image based on the game parameter values. The diffusion model includes one or a plurality of finetuning models that have been trained to achieve visual consistency in one or more visual characteristics of the generated image. The method further includes generating a game application including code and the image as a game asset, executing the generated code, and displaying a game interface of the game application. Code and images for the game application can be regenerated based on user input. The finetuning models can be LoRA models, for example.

### BACKGROUND

Development of computer games is a time consuming and complicated endeavor that requires significant expertise. The effort to generate code and game content, such as images and text, can be significant. Recently, machine learning models have been developed that can generate code, natural language text, and images. However, integrating such models into computer game development has proven difficult in practice, due to the variability of the output of the machine learning models, and the lack of appropriate development tools. As a result, the generation of computer games using machine learning models has been limited to date.

### SUMMARY

To address these issues, according to one aspect, a computing system is provided, including processing circuitry and associated memory storing instructions that when executed cause the processing circuitry to execute a game generation program including a game maker module, and display a chat interface of the game maker module. The chat interface is configured to receive natural language user input; and execute a language model agent of the game maker module. The language model agent is configured to generate a language model prompt including the natural language user input and language model instructions, transmit the language model prompt to a generative language model, and receive a response from the generative language model, the response including game parameter values. The processing circuitry is further configured to execute a diffusion model agent. The diffusion model agent is configured to generate a diffusion model prompt based on the game parameter values and diffusion model instructions, transmit the diffusion model prompt to a diffusion model, and receive an image generated by the diffusion model. The game maker module is configured to generate a game application including code and the image as a game asset.

In this aspect, the game generation program can further include a game engine configured to execute the code generated by the game maker module, and display a game interface of the game application upon execution of the code.

Further in this aspect, the chat interface of the game maker module can be configured to receive a game adjustment input and regenerate the code and/or image of the game application using the generative language model and diffusion model based on the game adjustment input, and the game engine can be configured to execute the regenerated code and display an updated game interface of the game application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic illustration of a computing system for computer game generation using a generative language model and diffusion model, according to one example implementation.

FIG. 2 is a schematic illustration of a game generation data flow of the computing system of FIG. 1.

FIG. 3 is a schematic illustration of generation of a background image by the computing system of FIG. 1.

FIG. 4 is a schematic illustration of generation of a multi-view player character image by the computing system of FIG. 1.

FIG. 5 is a schematic illustration of generation of non-player character images by the computing system of FIG. 1.

FIG. 6 is a schematic illustration of a game object output schema and gameplay logic output schema used by the computing system of FIG. 1.

FIG. 7 illustrates the re-generation of a game application based on user input, and features an original graphical user interface of the game application at the top and an updated graphical user interface of the regenerated game application at the bottom.

FIGS. 8A and 8B illustrate a flowchart of a computerized method according to one example implementation of the present disclosure.

FIG. 9 shows a schematic view of an example computing environment in which the computing system of FIG. 1 may be enacted.

### DETAILED DESCRIPTION

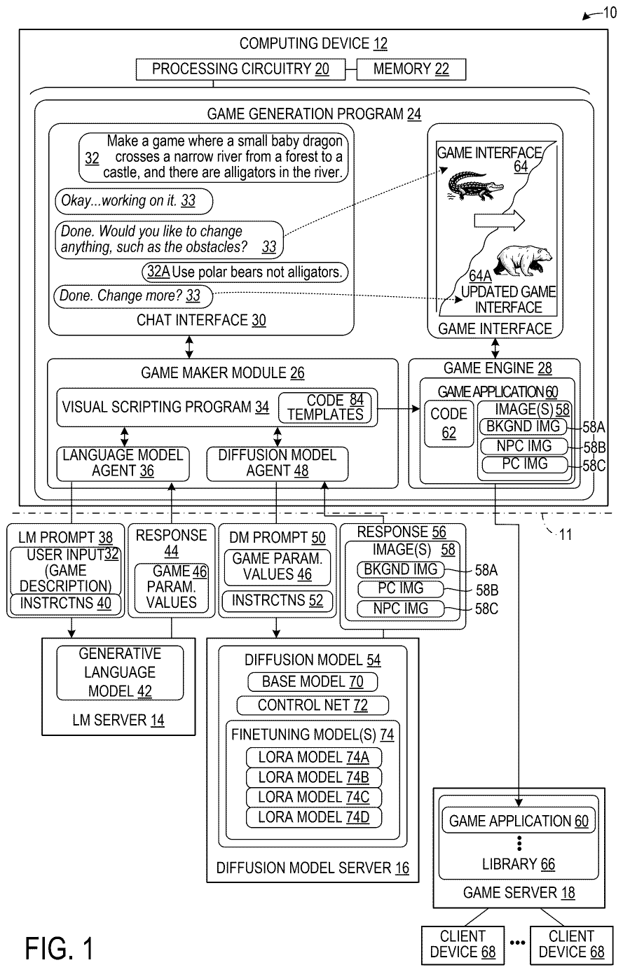

As shown in FIG. 1 a computing system 10 is provided for computer game generation based on natural language input from a user. The computing system 10 includes a computing device 12, language model server 14, diffusion model server 16, and game server 18. These devices are configured to communicate with each other via a computer network 11, such as the Internet. Although the computing device 12 and servers 14, 16, 18 of FIG. 1 are shown as single devices, it will be appreciated that the functions they perform may be distributed across a plurality of distributed devices, or combined into a smaller number of devices or a single device.

Computing device 12 includes processing circuitry 20 and associated memory 22 storing instructions that when executed cause the processing circuitry 20 to execute a game generation program 24 including a game maker module 26 and a game engine 28. The game maker module 26 is configured to display a chat interface 30. The chat interface 30 is configured to receive natural language user input 32 and enable a user to conduct a turn based dialog with the game generation program 24 using a generative language model 42, which produces responses 33. A visual scripting program 34 can be provided as part of the game maker module 26, and configured to define a game generation workflow using, for example, a graph based visual programming interface. The game generation workflow generally begins with a user prompt, and proceeds through a language model phase, a diffusion agent model phase, and a code generation phase.

Processing circuitry 20 is configured to execute a language model agent 36 of the game maker module 26. The language model agent 36 is configured to generate a language model prompt 38 including the natural language user input 32 and language model instructions 40, transmit the language model prompt 38 to a trained generative language model 42 executed on the language model server 14, and receive a response 44 from the trained generative language model 42. The response includes game parameter values 46.

An example language model prompt 38 is as follows:

“You are a computer game programmer writing a computer game based upon the following user input: ‘Make a game where a small baby dragon crosses a narrow river from a forest to a castle, and there are alligators in the river.’ Please respond to the following questions regarding game parameter values for the game, based only on this user input.
1. What type of game does the user input describe? Please answer from the following game types: Crossing Game, Platform Game, Racing Game, or Undetermined. Do not guess. Only return an answer with high confidence.
2. If the answer to [1] is a Crossing Game, then please respond further with whether the game is oriented vertically or horizontally. If not determinable from the user input, respond vertically.
3. If the answer to [1] is a Crossing game, then please respond further with words describing the visual appearance of the danger region.
4. If the answer to [1] is a Crossing game, then please respond further with the height of the danger region. Limit your answer to narrow, medium, or wide. Alternatively, express the height in terms of percentage of a maximum possible height.
5. If the answer to [1] is a Crossing game, then please respond further with words describing the visual appearance of the start region.
6. If the answer to [1] is a Crossing game, then please respond further with words describing the visual appearance of the goal region.
7. If the answer to [1] is a Crossing game, then please respond further with words describing the visual appearance of a player character.
8. If the answer to [1] is a Crossing game, then please respond further with words describing the visual appearance of a non-player character.
9. If the answer to [1] is a Crossing game, then please respond further with words describing the win condition based on the user input. If no win condition is expressed in the user input, answer that the win condition is the player character reaching the goal region.
10. If the answer to [1] is a Crossing game, then please respond further with words describing the visual appearance of a trophy for winning the game. If no description is provided, please answer that the trophy is cup shaped.
11. If the answer to [1] is a Crossing game, then please respond further with words describing the lose conditions for losing the game. If no lose condition is described, answer that the lose condition is satisfied when the player character contacts a non-player character or object in the danger region.
12. If the answer to [1] is a Crossing game, then please respond further with words describing the visual appearance of a losing graphic displayed when the game is lost.” If no description of the lose graphic is provided, please answer that the losing graphic is a sad face.”
   In the above example, text apart from user input 32 (in single quotes) is an example of language model instructions 40.
   An example language model response 44 to the above language model prompt 38, is as follows:
1. Crossing Game
2. The game is oriented horizontally.
3. River
4. Narrow
5. Forest
6. Castle
7. Baby dragon
8. Alligators
9. The game is won when the player character reaches the goal region.
10.The trophy is cup shaped.
11.The game is lost when the player character contacts a non-player character or object in the danger region.
12.The losing graphic is a sad face.
   The above answers 1-12 are examples of game parameter values 46. It will thus be appreciated that the game parameter values are typically strings, but can be formatted in other formats if desired.

Processing circuitry 20 is further configured to execute a diffusion model agent 48 of the game maker module 26. The diffusion model agent 48 is configured to generate a diffusion model prompt 50 based on the game parameter values 46 and diffusion model instructions 52, transmit the diffusion model prompt 44 to a diffusion model 54 executed on the diffusion model server 16, and receive a response 56 including one or more images 58 generated by the diffusion model 54. It will be appreciated that several diffusion model prompts 50 would be generated based on the example language model response 44 described above.

An example diffusion model prompt 50 is as follows: “Draw an [insert answer from [8] above: “alligator”]. The drawing should be in black and white on a white background, in a cartoon style, from a side view, oriented such that it faces to the left.” In this example diffusion model prompt 50, the “alligator” is a game parameter value from the language model response 44, and the remaining text is an example of diffusion model instructions 52. Similar diffusion model prompts can be generated for the various other images 58 generated herein.

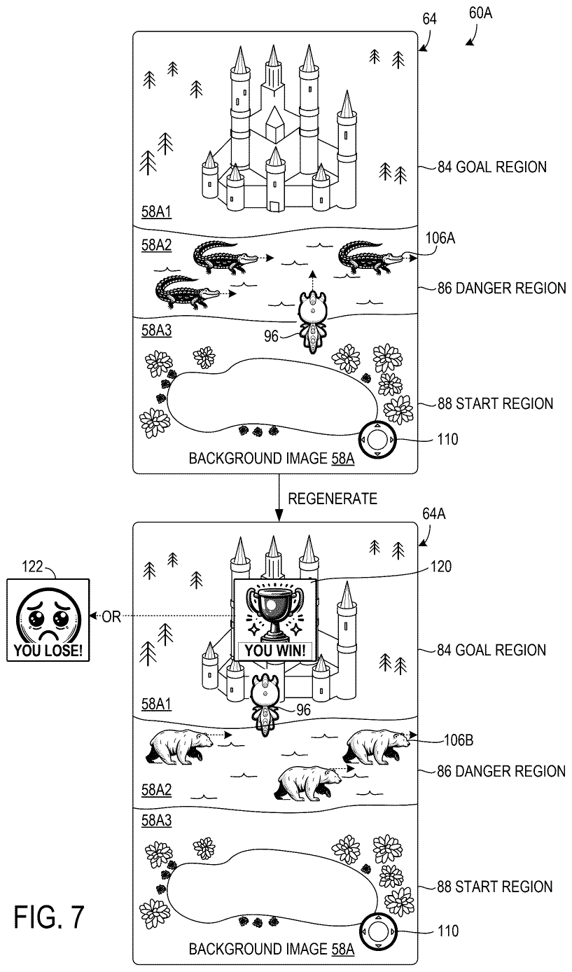

The game maker module 26 is configured to generate a game application 60 including code 62 and one or more images 58 as a game asset. As shown, the one or more images 58 may be a background image 58A, a player character image 58B, and a non-player character image 58C. The code 62 is generated using code templates 84 that contain prebuilt code for each of the game types known to the game generation program 24. Thus, for the example described herein, a code template for a Crossing Game would be selected by the visual scripting program 34. The code templates 84 are designed to work with a default set of game assets, such as images 58 for a player character, non-player character, objects, background, etc., which are supplied by the diffusion model 54 and packaged by the visual scripting program 34 into the game application 60 when the code 62 is generated. The code template 59 also includes certain variable game logic, which can be adjusted based on the game parameter values 46 in the language model response 44. For example, if the user input 32 described the alligators as “fast”, then code template 84 can be adjusted to include a fast speed setting for the non-player character (see, e.g., non-player character gameplay logic 76E2 in FIG. 6 for this purpose).

The game engine 28 of the game generation program 24 is configured to execute the code 62 generated by the game maker module 26, and display a game interface 64 of the game application 60 upon execution of the code 62. The generation of the code 62 and display of the game interface 64 can occur substantially in real time, for example, with a delay of a 60, 30, or 10 seconds or less (during which time “Okay . . . working on it.” displayed in the chat interface 30), so that the user can quickly see the results of the game generation. The user can evaluate the game using the game interface 64.

To prompt the user for feedback on the displayed game application, the chat interface 30 can be configured to display a feedback eliciting message to the user such as “Done. Would you like to change anything, such as the obstacles?” In response, the chat interface 30 of the game maker module 26 is configured to receive a game adjustment input 32A from the user and to regenerate the code 62 and/or one or more images 58 of the game application 60 using the generative language model 42 and diffusion model 54 based on the game adjustment input 32A (“Use polar bears not alligators.”). The game engine 28 is configured to execute the regenerated code 62 for the game application 60 and display an updated game interface 64A of the regenerated game application 60. To determine what game parameter values have changed, the game adjustment input 32A is feed as user input in a language model prompt 38 to the generative language model 42, and game parameter values 46 for the updated game application 60 are returned, and based upon these, the diffusion model 54 is used to generate updated images 58 as game assets.

Once the user is satisfied with the game application, the user can issue a command to publish the game application 60 as one of a plurality of downloadable game applications 60 in a game library 66 of the game server 18. Other users of client devices 68 can access and play the game application 60 via the game server, once the game application 60 has been published in this manner.

The diffusion model 54 can include a base model 70 and one or a plurality of finetuning models 74. The finetuning models 74 can be, for example, one or a plurality of Low Rank Adaptation (LoRA) models 74A-74D that have been trained to adapt the image generated by the diffusion model to achieve visual consistency in one or more visual characteristics of the generated images. For example, the visual characteristics can include the size and perspective of the images. The diffusion model 54 can further include a control net 72 configured to guide generation of the images.

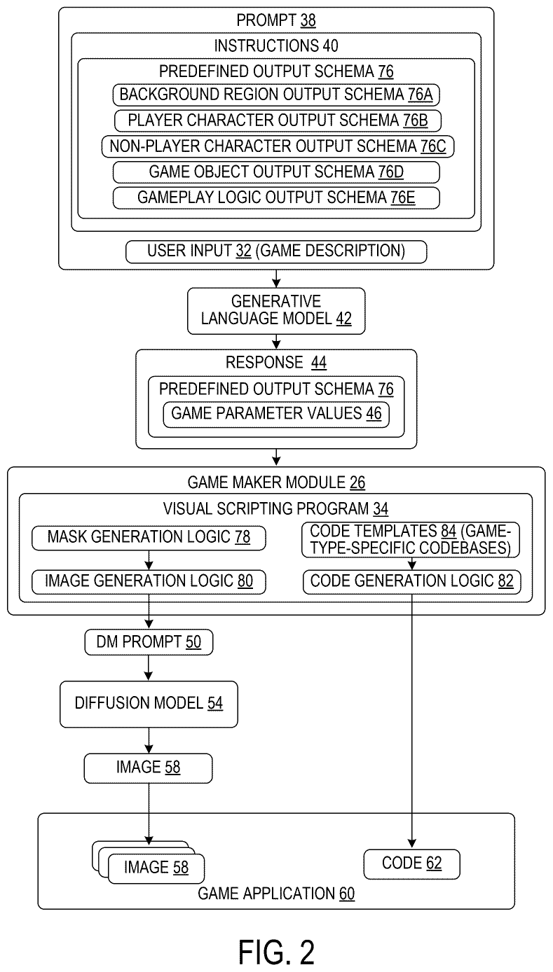

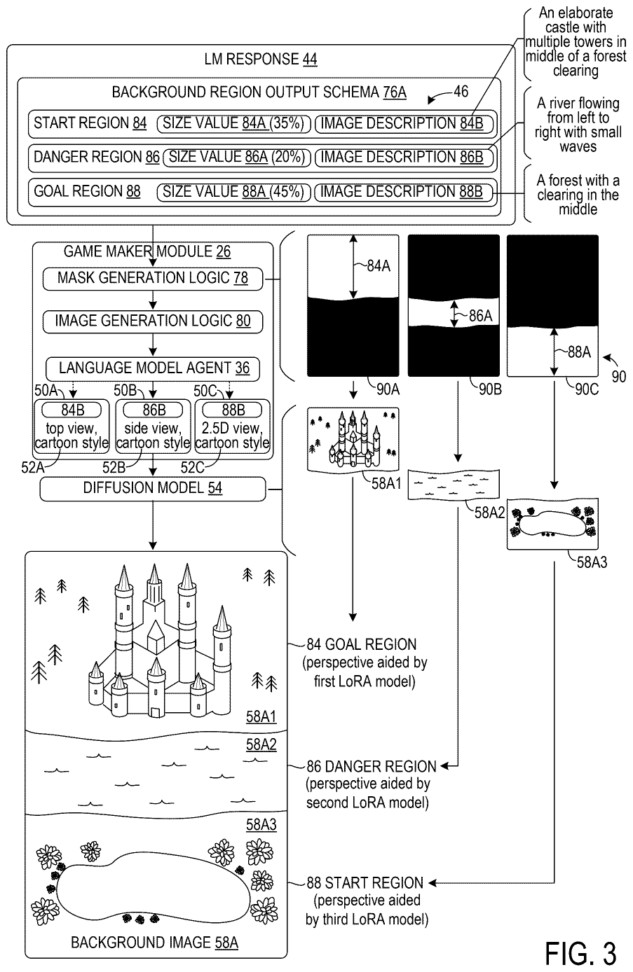

Turning now to FIG. 2, a process flow of the computing system 10 of FIG. 1 for generating one or more images and code in the gaming application is illustrated. The generative language model instructions 40 include a predefined output schema 76, and the game parameter values 46 out from the generative language model 42 are organized according to the predefined output schema 76. The example language model prompt 40 discussed above includes 12 questions that are one example of such a predefined output schema 76. The game parameter values 46 can include a variety of values used to generate the game application 60. In one particular example discussed in relation to FIG. 3 below, the game parameter values 46 can include a size value defining a size of one or a plurality of background regions. The predefined output schema can include a plurality of individual schemas used to generate different game assets. For example, the predetermined output schemas 76 can include background region output schema 76A, player character output schema 76C, object output schema 76D, and gameplay logic output schema 76E, which will be described in more detail in relation to FIGS. 3-6.

The visual scripting program 34 of the game maker module 26 includes mask generation logic 78 configured to generate a mask image based on the received game parameter values 46, which may include size, shape, or position parameters defining the location of a background image, player character, non-player character, or object in an image displayed in the game interface 64. The mask generation logic 78 typically generates the mask images using deterministic programming commands rather than calls to diffusion model 54, although diffusion model 54 could be used to generate the mask images if desired.

The visual scripting program 34 of the game maker module 26 further includes image generation logic 80, configured to formulate the diffusion model prompt 50 and send it to the diffusion model 54, causing the diffusion model 54 to generate image 58.

The visual scripting program 34 of the game maker module 26 further includes code generation logic 82 that is configured to generate code 62 based on the code template 59 for the type of game that is described by the user in the user input 32. For example, the game parameter values 46 can include a game type that is identified by the generative language model 42, the game type being selected by the generative language model 42 from a plurality of predetermined game types 42 listed in the gameplay logic output schema 76E of predefined output schema 76. (See Question 1 in example language model prompt 38 above.) Thus, the code generation logic 82 can select a code template 84 associated with the game type outputted in the game parameter values 46 in the predefined output schema 76 of response 44, and generate code 62 for the game application 60 based thereon.

Turning now to FIG. 3, an example process of generating a background image 58A is shown. In the depicted example, the background image 58A includes three regions: a start region 88, a danger region 86, and a goal region 84. This three-part background image 58A is used for a type of game application 60 that is a crossing game, in which a user attempts to move the player character from the start region 88, through the danger region 86 populated by non-player characters and/or objects that result in a lose condition if the player character touches them, to the goal region 84. A win condition may be set by the gameplay logic that if the player character completely enters goal region, the game is won. The crossing game is oriented vertically in the illustrated example, but it will be appreciated that orientation can be determined by the user input 32 or generative language model 42 by assigning a game parameter value 46 to the predetermined output schema 76. (See Question 2 in the example language model prompt 38 above.)

The background region output schema 76A includes a plurality of game parameter values 46 generated by the generative language model 42, namely, a size value 84A, 86A, 88A and an image description 84B, 86B, 88B for each of the start region 84, danger region 86, and goal region 88. The size value 84A, 86A, 88A may be expressed as a numerical value, such a number of pixels or a percentage of a maximum size, etc., or as a word such as “narrow,” “medium,” or “wide”. In the example, the size values are 35% for the start region size value 84A, 20% for the danger zone size value 86A, and 45% for the goal region size value 88A. If desired, only a single size value of the danger region may be specified, and the danger region may be vertically positioned in a middle of the screen, and the size for the other regions may be computed accordingly. The image descriptions 84B, 86B, 88B can be as simple as “Castle,” “River,” and “Forest” as in the above example language model response 44, but also could be embellished if such instructions were provided to the generative language model 42. For example, a prompt that asked the generative language model 42 to provide a detailed description of each region might result in “An elaborate castle with multiple towers in the middle of a forest clearing,” “A river flowing from left to right with small waves,” and “A forest with a clearing in the middle,” respectively. Whether terse or detailed, image descriptions 84B, 86B, 88B are natural language text that has been generated by the generative language model 42 and serve as part of the diffusion model prompts 50, as discussed below.

The mask generation logic 78 can be configured to generate one or a plurality of background region mask images based on the size value 84A, 86A, 88A received as one of the game parameter values 46 in background region output schema 76A. In the example of FIG. 3, based on the size values, the mask generation logic 78 is configured to generate mask images 90, including a start region mask image 90A, danger region mask image 90B, and goal region mask image 90C. The height of the unmasked area in each region is set by the size value 84A, 86A, 88A for the region.

The image generation logic 80 is configured to manage the image generation workflow for generating individual background region images 58A1, 58A2, 58A3 for each of the background regions, and then stitching those images together to form the background image 58A. At the request of the image generation logic 80, the diffusion model agent 36 is configured to send the background region mask images 90A, 90B, 90C to the diffusion model 54 with a corresponding diffusion model prompt 50, to cause the diffusion model 54 to generate corresponding images 58A1, 58A2, and 58A3 within the unmasked region of each mask image 90A, 90B, 90C. This is typically done with three separate calls to the diffusion model 54, each call having a different diffusion model prompt 50A, 50B, 50C including a corresponding image description 84B, 86B, 88B for the particular region (start region 84, danger region 86, and goal region 88) and being accompanied by the corresponding mask image 90A, 90B, or 90C. In addition, each diffusion model prompt 50A, 50B, 50C includes diffusion model instructions 52A, 52B, 52C to ensure the perspective, style, and quality of the generated image for each region. In the depicted example, three diffusion model prompts are shown, with “top view, cartoon style,” “side view, cartoon style,” and “2.5D, cartoon style” as the instructions. In addition, other style or quality parameters may be used to indicate the style or quality of the background images, such as “at a close distance,” “at a medium distance,” or “at a far away distance”/“large,” “medium,” or small”/“in high detail,” “in medium detail,” “in low detail,” etc.

As a result, each of separate images 58A1, 58A2, 58A3 is generated for each of the background regions 84, 86, 88 in the appropriate style and perspective for each region. Thus, the perspective of the three images 58A1, 58A2, 58A3 shown in the background image 58A1 is rendered differently, with the goal region image 58A1 being rendered in 2.5 dimensions, the danger region image 58A2 being rendered in side view, and the start region image 58A1 being rendered in top view. The image generation logic then aggregates the separate images 58A1, 58A2, 58A3 for each region into the composite background image 58A.

To ensure the consistency and accuracy of the appearance of the different perspectives, a first finetuning model 74 (e.g., first LoRA model 74A of FIG. 1) can be trained on a first diffusion model training prompt including diffusion model instructions 52 for images from top (i.e., overhead) perspective and a first set of ground truth finetuning images rendered from the top (i.e., overhead) perspective, a second finetuning model 74 (e.g., second LoRA model 74B of FIG. 1) can be trained on a second diffusion model training prompt including diffusion model instructions 52 for images from a side perspective and a second set of ground truth finetuning images rendered from the side perspective, and the third finetuning model (e.g., third LoRA model 74C) can be trained on a third diffusion model training prompt including diffusion model instructions 52 for images from a two and a half dimensional (2.5D) perspective and a second set of ground truth finetuning images rendered from the 2.5D perspective. In this way, the three LoRA models 74A-74C can help ensure the perspectives are accurately rendered for the different background regions by the fine tuning model 54.

Further, continuing with FIG. 3, image description 84B can include a description of the 2.5D perspective, image description 86B can include a description of the side view, and image description 88B can include a description of the top view. When the diffusion model 54 processes each prompt 50 with these perspective descriptions in the instructions 52, the three LoRA models operate to ensure the images 58A1, 58A2, 58A3 of each region in the final rendered background image 58A are faithfully reproduced in the instructed perspectives. The density of features in the final rendered background image 58A can be controlled through a control net 72, shown in FIG. 1. The control net 72 can be set so that the features are not too dense, which can be distracting to the user, and not too sparse, which can lack visual interest. The control net can be trained by providing it with ground truth images having appropriate density of features during training, as few shot learning examples.

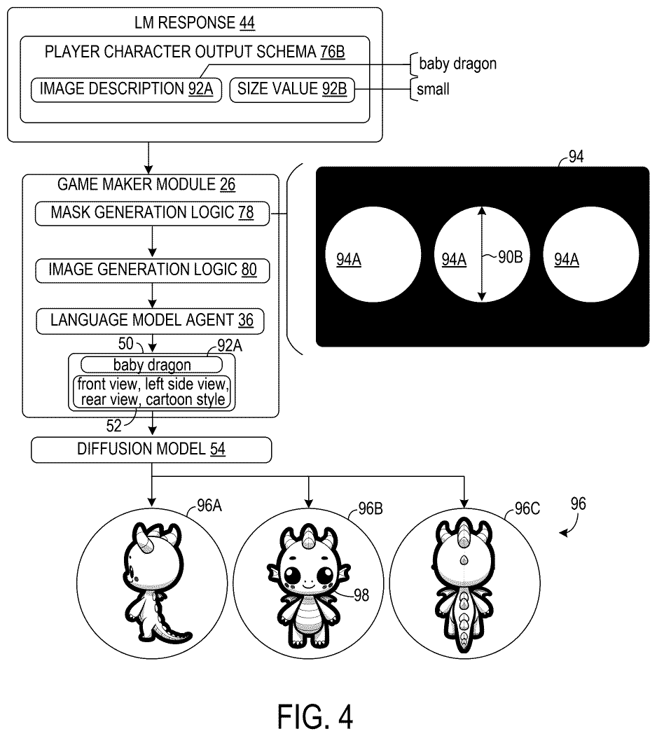

FIG. 4 illustrates the process of generating images for a player character. In the illustrated example, diffusion model 54 has been trained to generate multiple images of character (i.e., multi-view generation), in different orientations. Alternatively, a single view could be generated, if desired. The language model response 44 may additionally include a player character output schema 76B that has been populated according to the language model instructions 40 and user input 32 by the generative language model 42. The player character output schema includes an image description 92A (e.g., baby dragon) describing the player character, and a size value 92B (e.g., small) for the generated images. The image description 92A is outputted in the response 44 by the generative language model 42 based on the user input 32, as is the size value. The game maker module 26 is configured to generate a predetermined number of views 96 via the multi-view generation process of the diffusion model 54. In this example three views 96 are shown, but this number may be varied as needed, according to a configuration setting or program logic of the game maker module 26.

The mask generation logic 78 generates a mask image 94 including the predetermined number of unmasked regions 94A, each unmasked region having a size corresponding to the size value 92B, as shown. The diffusion model 54 is configured to generate a plurality of views 96 of a player character 98, with the player character 98 oriented in a plurality of orientations in the views 96. In the depicted example, the diffusion model 54 generates a left side view 96A, front view 96B, and rear view 96C, within the unmasked regions. Other views may be generated as desired.

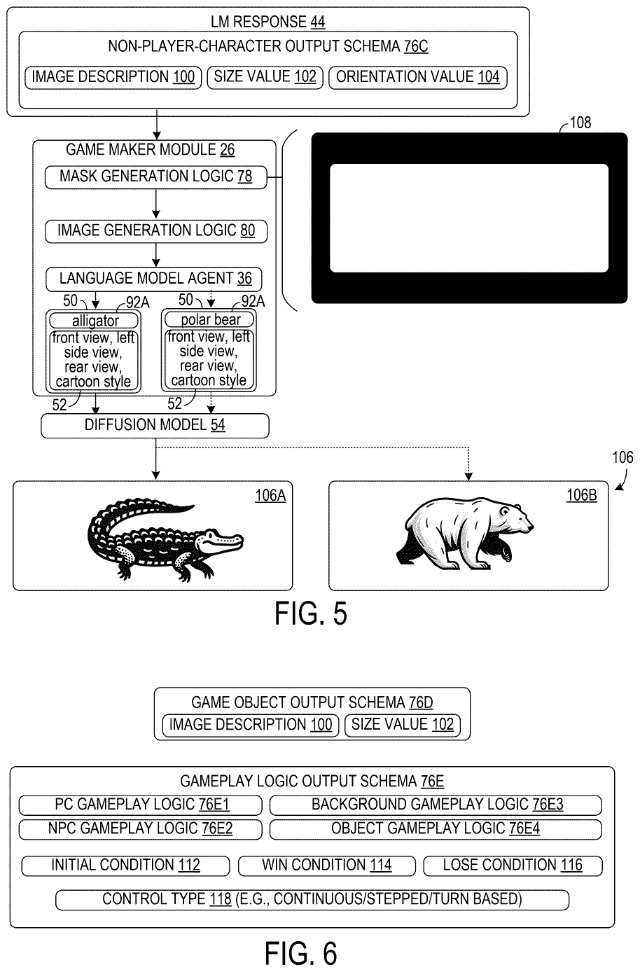

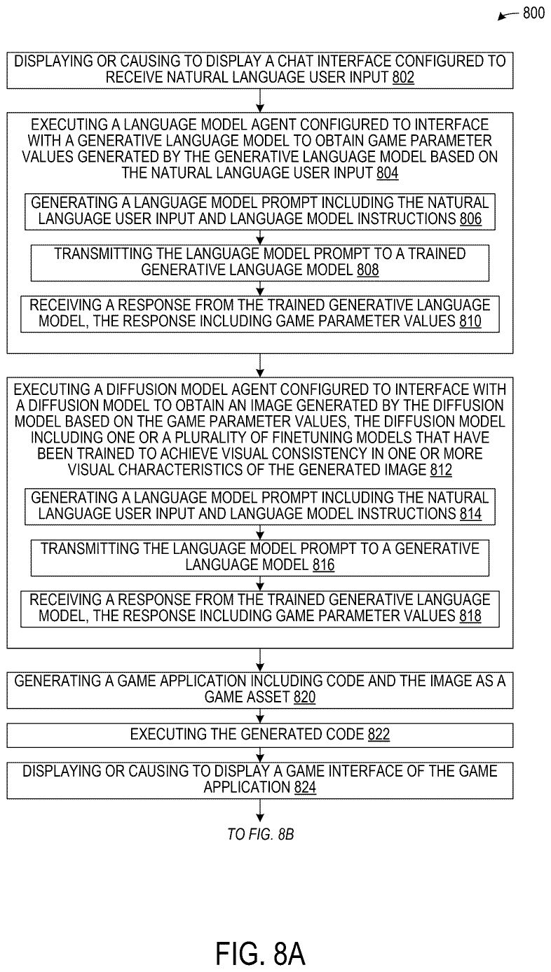

FIG. 5 illustrates a process of generating an image of a non-player character 106. The language model response 44 can further include a non-player character output schema 76C, which in turn includes an image description 100 (e.g., alligator or polar bear), a size value 102 (e.g., medium), and orientation value 104 (e.g., left or right) indicating a direction that the character should face. A mask image 108 having an unmasked region that is sized according to the size value 102 is generated by the mask generation logic 78. Since no size value was indicated in the user prompt 32, the mask generation can generate a mask of a default size contained in the mask generation logic settings. The diffusion model 54 is configured to generate a non-player character 106 from a side view facing in the direction indicated by the orientation value 105, within an unmasked region of the mask image 108. The fourth LoRA model 74D can be trained to ensure that the generated images are facing in the requested direction, such as left, right, as off the shelf models can have difficulty in this regard. The code generation logic 82 is configured to generate code 62 to populate the danger region 86 (see FIG. 3) with the non-player characters 106, oriented in a same orientation (e.g., facing right) indicated by the orientation value 104 and travelling across the danger region 86, as shown in FIG. 7 at top. In the example shown, a first pass through the nonplayer character generation process generates an image of an alligator as a first nonplayer character 106A, and upon receiving game adjustment input 32A (see FIG. 1), a second pass through the nonplayer character generation process is made using “polar bears” as the image description 100 of the non-player character instead of “alligator”. As a result, an image of a polar bear as a second nonplayer character 106B is generated by the diffusion model 54.

FIG. 6 illustrates two additional output schemas, namely, game object output schema 76D and a gameplay logic output schema 76E. The gameplay logic output schema 76E defines various game play parameters for each of the user controlled and computer controlled elements of the game application 60. The gameplay logic output schema 76E can include player character gameplay logic 76E1, non-player character gameplay logic 76E2, background gameplay logic 76E3, and object gameplay logic 76E4. For example, the player character gameplay logic 76E1 can define a controllable player character 98 that is controlled by user inputs entered via a touch control that is defined in code 62. Accordingly, as shown in FIG. 7 a directional touch control icon 110 for controlling the player character can be presented on the game interface 64. Alternatively, user inputs via a virtual keyboard displayed on a touch screen; body pose, hand gestures, or facial movements detected by a camera, accelerometer measurements detected by an on-board inertial measurement unit (IMU), or voice inputs detected by a microphone can alternatively be designated. The gameplay logic output schema 76E can further include a set of initial conditions (player character, non-player character, and object placements, etc.) at which the game commences, a win condition (e.g., player character touches castle), and a lose condition (e.g., player character touches non-player character). The gameplay logic output schema 76E can also include a control type that defines how the control inputs are applied to move the player character through the game. The control type can be selected from continuous control, stepped control, and turn-based control, for example.

The gameplay logic output schema 76E can further define how many rows of non-player characters cross the danger region, the frequency and or speed at which the non-player characters cross the danger region, the direction (left to right, right to left, top to bottom, bottom to top, or a combination thereof, etc.) in which the non-player characters cross the danger region, and the path (e.g., linear, curvy, etc.) on which the non-player characters cross the danger region. The gameplay logic output schema 76E can further define whether the background regions 84, 86, 88 are oriented vertically or horizontally, with a vertical orientation being depicted in FIG. 3. The gameplay logic output schema 76E can further define user inputs on which the game starts and stops, should a player decide to quit mid-game. If desired, the player character gameplay logic schema 76E1 and/or non-player character gameplay logic schema 76E2 can define that the player character 98 and/or non-player character 106 can jump upon detection of a jump input such as a tap on the screen. If desired, the objects, for example, may be a trophy 120 awarded to a user who wins the game, or losing graphic 122 displayed when a user loses the game, examples of which are shown in FIG. 7, discussed below.

As a user might not understand what features can be added or modified via the chat interface, the generative language model 42 can be configured to offer hints. Thus, the generative language model 42 can be instructed via instructions 40 to remind the user that they can provide input to adjust game parameter values 46 that the user has not yet adjusted, and explain how those game parameter values 46 affect gameplay. Thus, if a user requests one row of moving non-player characters in the danger region, or doesn't specify how many rows to include in the danger region in user input 32, the generative language model 42 could respond with “Your game has been generated to include one row of non-player characters, in the form of alligators. This should make the game easy to play. Remember, you can adjust the difficulty level by adding more rows of non-player characters in the future if needed.” This can be accomplished by providing language model instructions 40 to suggest a modification to the user.

It will be appreciated that the game application generation cycle (e.g., user input, generation, execution, and display of the game interface 64) can happen in real-time or near real-time. While some latency naturally occurs due to network communications among computing device 12, the language model server 14, and the diffusion model server 16, and also some latency occurs when the generative language model 42 and diffusion model 54 perform their generation processes, in a typical implementation the user can expect to wait only a matter of seconds for the game interface 64 to be rendered. This wait time can be minimized by placing processing time constraints on the generative language model 42 and diffusion model 54 regarding the maximum processing time to expend responding to the language model prompt 38 and diffusion model prompt 50. In this way, by “in real-time” or “in near real-time”, the present disclosure refers to a game application generation cycle that takes under 60 seconds to complete, and can be controlled to be completed in 30 seconds or less, or 10 seconds or less, for example, such that a user can reasonably wait for the result when designing a game.

FIG. 7 illustrates the rendered original graphical user interface 64 and updated graphical user interface 64A of the game application 60, which can be seen in this figure to be a crossing game 60A. The crossing game 60A features the rendered background image 58A including the plurality of background regions including the start region 58A3, the danger region 58A2, and a goal region 58A1. The diffusion model 54 described above generates a respective image 58A3, 58A2, 58A1 for each of the start region, danger region, and goal region based on respective image description 84B, 86B, 88B discussed above in relation to FIG. 3. In the crossing game 60A, the user operates the touch control 110 or other input control to control the player character 98, which in this case is rendered as a baby dragon. The users attempts to navigate the player character 98 vertically from the initial condition 112 of the player character 98 being positioned in the start region 88, up through the danger region 86, which features non-player characters 106 (or objects) oriented facing left and moving left across the screen horizontally, to the goal region 84. Contact with a non-player character 106 results in satisfaction of the lose condition 116, causing display of the losing graphic 122. Contact with the castle rendered in the goal region 84 results in satisfaction of the win condition 114, causing display of the trophy 120. The losing graphic 122 and trophy are rendered by diffusion model 54 based on user input 32, as processed by the generative language model 42, in a process similar to that described above for player characters 98 and non-player characters 106 with reference to FIGS. 4-5.

As discussed above, the user can repeatedly enter user input into the chat interface 30 to modify the game application 60. In updated user interface 64A, images for the game application 60 have been regenerated to include polar bears 106B as the non-player characters crossing the danger region 86, instead of alligators 106A. Various manner of updates can be requested by the user using the chat interface 30. As discussed above, the images for the player character, non-player character, objects, or background image can be regenerated based on user input, the size and orientation of the background regions can be updated, the game play logic associated with the player character, non-player character, objects, or background image can be adjusted, etc.

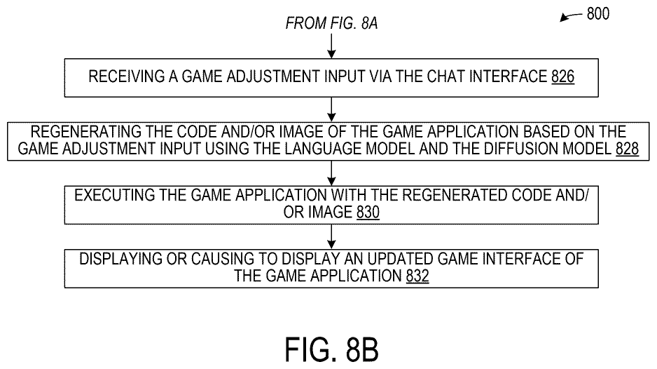

FIG. 8A illustrates a computerized method 800 according to one example implementation of the present disclosure. Method 800 can be implemented using the hardware and software components of computing system 10 described above, or other suitable hardware and software components. Method 800 includes, at 802, displaying or causing to display a chat interface configured to receive natural language user input. At 802, the method includes executing a language model agent configured to interface with a generative language model to obtain game parameter values generated by the generative language model based on the natural language user input. The language model agent can obtain game parameter values generated by the generative language model, at least in part by, at 806, generating a language model prompt including the natural language user input and language model instructions, at 808, transmitting the language model prompt to a trained generative language model, and at 810, receiving a response from the trained generative language model, the response including game parameter values. The method further includes, at 812, executing a diffusion model agent configured to interface with a diffusion model to obtain an image generated by the diffusion model based on the game parameter values. The diffusion model includes one or a plurality of finetuning models that have been trained to achieve visual consistency in one or more visual characteristics of the generated image, as described above. The visual characteristics can include a size, perspective, and/or an orientation of a player character, non-player character, object, or background image, for example.

The diffusion model agent can obtain the image generated by the diffusion model, at least in part by, at 814, generating a diffusion model prompt based on the game parameter values and diffusion model instructions, at 816, transmitting the diffusion model prompt to a diffusion model, and at 818, receiving an image generated by the diffusion model.

At 820, the method includes generating a game application including code and the image as a game asset. At 822, the method includes executing the generated code. And, at 824 the method includes displaying or causing to display a game interface of the game application.

Continuing with FIG. 8B, method 800 can further include, at 826, receiving a game adjustment input via the chat interface. At 826, the method can include regenerating the code and/or image of the game application based on the game adjustment input using the generative language model and the diffusion model. At 828, the method can include executing the game application with the regenerated code and/or image. And, at 830, the method can include displaying or causing to display an updated game interface of the regenerated game application. It will be appreciated that method 800, being implementable by computing system 10 described above, may further include various features and functions described with respect to computing system 10 above but not repeated here for the sake of brevity.

The above described systems and methods have the technical advantage of being able to accept natural language input, and generate game parameter values that can be used to generate game application code and images on-the-fly, in real-time. In this way, a user who may not be an expert in programming or visual design, can create computer games quickly according to the user's intent. Further, the visual consistency among the various generated elements, including the images of the player character, non-player character, objects, and background and the perspectives at which the images are rendered, can be improved by the use of the finetuning models and control net discussed above. In this way, visually jarring results are avoided and the overall user experience with the generated game is improved.

In some embodiments, the methods and processes described herein may be tied to a computing system of one or more computing devices. In particular, such methods and processes may be implemented as a computer-application program or service, an application-programming interface (API), a library, and/or other computer-program product.

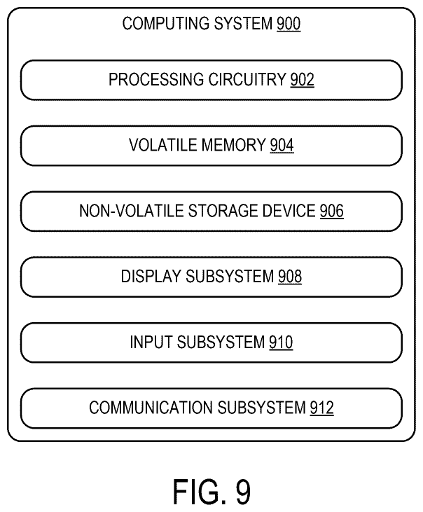

FIG. 9 schematically shows a non-limiting embodiment of a computing system 900 that can enact one or more of the methods and processes described above. Computing system 900 is shown in simplified form. Computing system 900 may embody the computer device 10 described above and illustrated in FIG. 2. Computing system 900 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 900 includes a logic processor 902 volatile memory 904, and a non-volatile storage device 906. Computing system 900 may optionally include a display subsystem 908, input subsystem 910, communication subsystem 912, and/or other components not shown in FIG. 9.

Logic processor 902 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 902 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 906 includes one or more physical devices configured to hold instructions executable by the logic processors to implement the methods and processes described herein. When such methods and processes are implemented, the state of non-volatile storage device 906 may be transformed—e.g., to hold different data.

Non-volatile storage device 906 may include physical devices that are removable and/or built-in. Non-volatile storage device 906 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 906 may include nonvolatile, dynamic, static, read/write, read-only, sequential-access, location-addressable, file-addressable, and/or content-addressable devices. It will be appreciated that non-volatile storage device 906 is configured to hold instructions even when power is cut to the non-volatile storage device 906.

Volatile memory 904 may include physical devices that include random access memory. Volatile memory 904 is typically utilized by logic processor 902 to temporarily store information during processing of software instructions. It will be appreciated that volatile memory 904 typically does not continue to store instructions when power is cut to the volatile memory 904.

Aspects of logic processor 902, volatile memory 904, and non-volatile storage device 906 may be integrated together into one or more hardware-logic components. Such hardware-logic components may include field-programmable gate arrays (FPGAs), program-and application-specific integrated circuits (PASIC/ASICs), program-and application-specific standard products (PSSP/ASSPs), system-on-a-chip (SOC), and complex programmable logic devices (CPLDs), for example.

The terms “module,” “program,” and “engine” may be used to describe an aspect of computing system 900 typically implemented in software by a processor to perform a particular function using portions of volatile memory, which function involves transformative processing that specially configures the processor to perform the function. Thus, a module, program, or engine may be instantiated via logic processor 902 executing instructions held by non-volatile storage device 906, using portions of volatile memory 904. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 908 may be used to present a visual representation of data held by non-volatile storage device 906. The visual representation may take the form of a graphical user interface (GUI). As the herein described methods and processes change the data held by the non-volatile storage device, and thus transform the state of the non-volatile storage device, the state of display subsystem 908 may likewise be transformed to visually represent changes in the underlying data. Display subsystem 908 may include one or more display devices utilizing virtually any type of technology. Such display devices may be combined with logic processor 902, volatile memory 904, and/or non-volatile storage device 906 in a shared enclosure, or such display devices may be peripheral display devices.

When included, input subsystem 910 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on-or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 912 may be configured to communicatively couple various computing devices described herein with each other, and with other devices. Communication subsystem 912 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 900 to send and/or receive messages to and/or from other devices via a network such as the Internet. The following paragraphs provide additional description of the subject matter of the present disclosure. According to a first aspect, a computing system is provided, comprising processing circuitry and associated memory storing instructions that when executed cause the processing circuitry to: execute a game generation program including a game maker module; display a chat interface of the game maker module, the chat interface being configured to receive natural language user input; execute a language model agent of the game maker module configured to interface with a generative language model to obtain game parameter values generated by the generative language model based on the natural language user input; execute a diffusion model agent configured to interface with a diffusion model to obtain an image generated by the diffusion model based on the game parameter values, the diffusion model including one or a plurality of finetuning models that have been trained to achieve visual consistency in one or more visual characteristics of the generated image, wherein the game maker module is configured to generate a game application including code and the image as a game asset.

In this aspect, the language model agent can be configured to obtain game parameter values at least in part by: generating a language model prompt including the natural language user input and language model instructions; transmitting the language model prompt to a generative language model; and receiving a response from the generative language model, the response including game parameter values. Further in this aspect, the diffusion model agent can be configured to obtain the image generated by the diffusion model at least in part by: generating a diffusion model prompt based on the game parameter values and diffusion model instructions; transmitting the diffusion model prompt to a diffusion model; and receiving an image generated by the diffusion model.

In this aspect, the game generation program further can include a game engine configured to: execute the code generated by the game maker module; and display a game interface of the game application upon execution of the code.

In this aspect, the chat interface of the game maker module can be configured to receive a game adjustment input and regenerate the code and/or image of the game application using the generative language model and diffusion model based on the game adjustment input, and the game engine can be configured to execute the regenerated code and display an updated game interface of the game application.

In this aspect, the language model instructions can include a predefined output schema, and the game parameter values output from the generative language model can be organized according to the predefined output schema.

In this aspect, the game parameter values can include a size value defining a size of one or a plurality of background regions.

In this aspect, the game maker module can include mask generation logic configured to generate one or a plurality of background region mask images based on the size value.

In this aspect, the diffusion model agent can be configured to send the background region mask images to the diffusion model with the diffusion model prompt, to cause the diffusion model to generate the prompt within the background region mask image.

In this aspect, the diffusion model can include a base model in addition to the one or a plurality of finetuning models, and the one or plurality of fine tuning models can be Low Rank Adaptation (LoRA) models that have been trained to adapt the image generated by the base model to achieve the visual consistency in one or more visual characteristics of the generated image.

In this aspect, the visual characteristics can include the size and perspective of the images.

In this aspect, the diffusion model further can include a control net configured to guide generation of the images.

In this aspect, the game application can be a crossing game featuring a plurality of background regions including a start region, a danger region, and a goal region, and the diffusion model can generate a respective image for each of the start region, danger region, and goal region based on respective image description.

In this aspect, the diffusion model can be further configured to generate a non-player character from the side view, and game play generation logic of the game make module can be configured to generate code to populate the danger region with the non-player characters, oriented in a same orientation and travelling across the danger region.

In this aspect, the one or a plurality of finetuning models include a finetuning model trained on a prompt including language model instructions for images from an overhead perspective and a set of finetuning images rendered from the overhead perspective.

In this aspect, the one or a plurality of finetuning models can include a finetuning model trained on a prompt including language model instructions for images from a side perspective and a set of finetuning images rendered from the side perspective.

In this aspect, the one or a plurality of finetuning models can include a finetuning model trained on a prompt including language model instructions for images from a two and a half dimensional (2.5D) perspective and a set of finetuning images rendered from the 2.5D perspective.

According to another aspect, a computerized method is provided, comprising: displaying or causing to display a chat interface configured to receive natural language user input; executing a language model agent configured to interface with a generative language model to obtain game parameter values generated by the generative language model based on the natural language user input; executing a diffusion model agent configured to interface with a diffusion model to obtain an image generated by the diffusion model based on the game parameter values, the diffusion model including one or a plurality of finetuning models that have been trained to achieve visual consistency in one or more visual characteristics of the generated image; generating a game application including code and the image as a game asset; executing the generated code; and displaying or causing to display a game interface of the game application.

In this aspect, the language model agent can obtain game parameter values generated by the generative language model, at least in part by: generating a language model prompt including the natural language user input and language model instructions; transmitting the language model prompt to a generative language model; and receiving a response from the generative language model, the response including game parameter values. Further in this aspect, the diffusion model agent can obtain the image generated by the diffusion model, at least in part by: generating a diffusion model prompt based on the game parameter values and diffusion model instructions; transmitting the diffusion model prompt to a diffusion model; and receiving an image generated by the diffusion model.

In this aspect, the visual characteristics include a size, perspective, and/or an orientation of a player character, non-player character, object, or background image.

According to another aspect, a computerized method is provided, comprising: displaying or causing to display a chat interface configured to receive natural language user input; executing a language model agent configured to interface with a generative language model to obtain game parameter values generated by the generative language model based on the natural language user input; executing a diffusion model agent configured to interface with a diffusion model to obtain an image generated by the diffusion model based on the game parameter values, the diffusion model including one or a plurality of finetuning models that have been trained to achieve visual consistency in one or more visual characteristics of the generated image, wherein the visual characteristics include a size, perspective, and/or an orientation of a player character, non-player character, object, or background image; generating a game application including code and the image as a game asset; executing the generated code; displaying or causing to display a game interface of the game application; receiving a game adjustment input via the chat interface; regenerating the code and/or image of the game application based on the game adjustment input using the generative language model and the diffusion model; executing the game application with the regenerated code and/or image; and displaying or causing to display an updated game interface of the game application.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
processing circuitry and associated memory storing instructions that when executed cause the processing circuitry to:
execute a game generation program including a game maker module;
display a chat interface of the game maker module, the chat interface being configured to receive natural language user input;
execute a language model agent of the game maker module configured to interface with a generative language model to obtain game parameter values generated by the generative language model based on the natural language user input;
execute a diffusion model agent configured to interface with a diffusion model to obtain an image generated by the diffusion model based on the game parameter values, the diffusion model including one or a plurality of finetuning models that have been trained to achieve visual consistency in one or more visual characteristics of the generated image, wherein
the game maker module is configured to generate a game application including code and the image as a game asset.

2. The computing system of claim 1, wherein
the language model agent is configured to obtain game parameter values at least in part by:
generating a language model prompt including the natural language user input and language model instructions;
transmitting the language model prompt to a generative language model; and
receiving a response from the generative language model, the response including game parameter values; and
the diffusion model agent is configured to obtain the image generated by the diffusion model at least in part by:
generating a diffusion model prompt based on the game parameter values and diffusion model instructions;
transmitting the diffusion model prompt to a diffusion model; and
receiving an image generated by the diffusion model.

3. The computing system of claim 2, wherein the game generation program further includes a game engine configured to:
execute the code generated by the game maker module; and
display a game interface of the game application upon execution of the code.

4. The computing system of claim 3, wherein
the chat interface of the game maker module is configured to receive a game adjustment input and regenerate the code and/or image of the game application using the generative language model and diffusion model based on the game adjustment input, and
the game engine is configured to execute the regenerated code and display an updated game interface of the game application.

5. The computing system of claim 2, wherein the language model instructions include a predefined output schema, and the game parameter values output from the generative language model are organized according to the predefined output schema.

6. The computing system of claim 2, wherein the game parameter values include a size value defining a size of one or a plurality of background regions.

7. The computing system of claim 6, wherein the game maker module includes mask generation logic configured to generate one or a plurality of background region mask images based on the size value.

8. The computing system of claim 6, wherein the diffusion model agent is configured to send the background region mask images to the diffusion model with the diffusion model prompt, to cause the diffusion model to generate the prompt within the background region mask image.

9. The computing system of claim 1, wherein the diffusion model includes a base model in addition to the one or a plurality of finetuning models, and wherein the one or plurality of fine tuning models are Low Rank Adaptation (LoRA) models that have been trained to adapt the image generated by the base model to achieve the visual consistency in one or more visual characteristics of the generated image.

10. The computing system of claim 9, wherein the visual characteristics include the size and perspective of the images.

11. The computing system of claim 1, wherein the diffusion model further includes a control net configured to guide generation of the images.

12. The computing system of claim 1, wherein the game application is a crossing game featuring a plurality of background regions including a start region, a danger region, and a goal region, and wherein the diffusion model generates a respective image for each of the start region, danger region, and goal region based on respective image description.

13. The computing system of claim 12, wherein the diffusion model is further configured to generate a non-player character from the side view, and game play generation logic of the game make module is configured to generate code to populate the danger region with the non-player characters, oriented in a same orientation and travelling across the danger region.

14. The computing system of claim 1, wherein the one or a plurality of finetuning models include a finetuning model trained on a prompt including language model instructions for images from an overhead perspective and a set of finetuning images rendered from the overhead perspective.

15. The computing system of claim 1, wherein the one or a plurality of finetuning models include a finetuning model trained on a prompt including language model instructions for images from a side perspective and a set of finetuning images rendered from the side perspective.

16. The computing system of claim 1, wherein the one or a plurality of finetuning models include a finetuning model trained on a prompt including language model instructions for images from a two and a half dimensional (2.5D) perspective and a set of finetuning images rendered from the 2.5D perspective.

17. A computerized method, comprising:
displaying or causing to display a chat interface configured to receive natural language user input;
executing a language model agent configured to interface with a generative language model to obtain game parameter values generated by the generative language model based on the natural language user input;
executing a diffusion model agent configured to interface with a diffusion model to obtain an image generated by the diffusion model based on the game parameter values, the diffusion model including one or a plurality of finetuning models that have been trained to achieve visual consistency in one or more visual characteristics of the generated image;
generating a game application including code and the image as a game asset;
executing the generated code; and
displaying or causing to display a game interface of the game application.

18. The computerized method of claim 17, wherein
the language model agent obtains game parameter values generated by the generative language model, at least in part by:
generating a language model prompt including the natural language user input and language model instructions;
transmitting the language model prompt to a generative language model; and
receiving a response from the generative language model, the response including game parameter values, and
the diffusion model agent obtains the image generated by the diffusion model, at least in part by:
generating a diffusion model prompt based on the game parameter values and diffusion model instructions;
transmitting the diffusion model prompt to a diffusion model; and
receiving an image generated by the diffusion model.

19. The computerized method of claim 17, wherein the visual characteristics include a size, perspective, and/or an orientation of a player character, non-player character, object, or background image.

20. A computerized method, comprising:
displaying or causing to display a chat interface configured to receive natural language user input;
executing a language model agent configured to interface with a generative language model to obtain game parameter values generated by the generative language model based on the natural language user input;
executing a diffusion model agent configured to interface with a diffusion model to obtain an image generated by the diffusion model based on the game parameter values, the diffusion model including one or a plurality of finetuning models that have been trained to achieve visual consistency in one or more visual characteristics of the generated image, wherein the visual characteristics include a size, perspective, and/or an orientation of a player character, non-player character, object, or background image;
generating a game application including code and the image as a game asset;
executing the generated code;
displaying or causing to display a game interface of the game application;
receiving a game adjustment input via the chat interface;
regenerating the code and/or image of the game application based on the game adjustment input using the generative language model and the diffusion model;
executing the game application with the regenerated code and/or image; and
displaying or causing to display an updated game interface of the game application.
